(19) United States
(12) Patent Application Publication
(10) Pub. No.: US 2014/0361675 A1
(43) Pub. Date: Dec. 11, 2014

(54) LIGHT SOURCE DEVICE AND FILAMENT

(71) Applicant: STANLEY ELECTRIC CO., LTD., Tokyo (JP)

(72) Inventor: Takahiro Matsumoto, Yokohama (JP)

(21) Appl. No.: 14/368,795

(22) PCT Filed: Dec. 20, 2012
(86) PCT No.: PCT/JP2012/083089

§ 371 Date: Jun. 25, 2014

(30) Foreign Application Priority Data
Dec. 26, 2011 (JP) 2011-284041

(51) Int. Cl. H01K 1/26; H01K 1/62

(52) U.S. Cl. CPC H01K 1/26; H01K 1/62
USPC 313/112

(57) ABSTRACT

A light source device comprising a filament showing high electric power-to-visible light conversion efficiency is provided. A light source device comprising a translucent gastight container, a filament disposed in the translucent gastight container, and a lead wire for supplying an electric current to the filament is provided. The filament comprises a substrate formed with a metal material and a white scatterer layer covering the substrate. To the white scatterer layer, a visible light-absorbing material that absorbs lights of visible region is added. The reflectance of the filament for visible lights is thereby made low, and the reflectance of the filament for infrared lights is thereby made high. Therefore, radiation of infrared lights is suppressed, and visible luminous efficiency can be enhanced.

### TECHNICAL FIELD

The present invention relates to a filament for light sources showing improved energy utilization efficiency, and it also relates to, in particular, a light source device, especially an incandescent light bulb, a near infrared light source, and a thermoelectronic emission source, utilizing such a filament.

### BACKGROUND ART

There are widely used incandescent light bulbs which produce light with a filament such as tungsten filament heated by flowing an electric current through it. Incandescent light bulbs show a radiation spectrum close to that of sunlight providing superior color rendering properties, and show high electric power-to-light conversion efficiency of 80% or higher. However, 90% or more of the components of the light radiated by incandescent light bulbs consists of infrared radiation components as shown in FIG. 1 (in the case of 3000K in FIG. 1). Therefore, the electric power-to-visible light conversion efficiency of incandescent light bulbs is as low as about 15 lm/W. In contrast, the electric power-to-visible light conversion efficiency of fluorescent lamps is about 90 lm/W, which is higher than that of incandescent light bulbs. Therefore, although incandescent light bulbs show superior color rendering properties, they impose larger environmental loads compared with fluorescent lamps.

Various proposals have been made so far as attempts for realizing higher efficiency, higher luminance and longer lifetime of incandescent light bulbs. For example, Patent documents 1 and 2 propose a configuration for realizing a higher filament temperature, in which an inert gas or halogen gas is enclosed in the inside of an electric bulb so that the evaporated filament material is halogenated and returned to the filament (halogen cycle) to obtain higher filament temperature. Such a lamp is generally called halogen lamp, and such a configuration provides the effects of increasing electric power-to-visible light conversion efficiency and prolonging filament lifetime. In this configuration, type of the gas to be enclosed and control of the pressure thereof are important for obtaining increased efficiency and prolonged filament lifetime.

Patent documents 3 to 5 disclose a configuration in which an infrared light reflection coating is applied on the surface of electric bulb glass to reflect infrared lights emitted from the filament and return them to the filament, so that the returned lights are absorbed by the filament. The filament is re-heated with the infrared lights absorbed by the filament to attain higher efficiency.

Patent documents 6 to 9 propose a configuration that a microstructure is produced on the filament itself, and infrared radiation is suppressed by the physical effects of the microstructure to increase the rate of visible light radiation.

### PRIOR ART REFERENCES

### Patent Documents

Patent document 1: Japanese Patent Unexamined Publication (Kokai) No. 60-253146
Patent document 2: Japanese Patent Unexamined Publication (Kokai) No. 62-10854
Patent document 3: Japanese Patent Unexamined Publication (Kokai) No. 59-58752
Patent document 4: Japanese Patent Unexamined Publication (Kohyo) No. 62-501109
Patent document 5: Japanese Patent Unexamined Publication (Kokai) No. 2000-123795
Patent document 6: Japanese Patent Unexamined Publication (Kohyo) No. 2001-519079
Patent document 7: Japanese Patent Unexamined Publication (Kokai) No. 6-5263
Patent document 8: Japanese Patent Unexamined Publication (Kokai) No. 6-2167
Patent document 9: Japanese Patent Unexamined Publication (Kokai) No. 2006-205332

### Non-Patent Document

Non-patent document 1: F. Kusunoki et al., Jpn. J. Appl. Phys., 43, 8A, 5253 (2004)

### SUMMARY OF THE INVENTION

### Object to be Achieved by the Invention

Although the effect for prolonging the lifetime is realizable with the technique of using the halogen cycle such as those disclosed in Patent documents 1 and 2, it is difficult to markedly improve the conversion efficiency with such a technique, and the efficiency currently obtainable thereby is about 20 lm/W.

Further, the technique of reflecting infrared lights with an infrared light reflection coating to cause the reabsorption by the filament such as those described in Patent documents 3 to 5 cannot provide efficient reabsorption of infrared lights by the filament, since the filament has a high reflectance for infrared lights as high as 70%. Furthermore, the infrared lights reflected by the infrared light reflection coating are absorbed by the parts other than the filament, for example, the part for holding the filament, base, and so forth, and are not fully used for heating the filament. For these reasons, it is difficult to significantly improve the conversion efficiency with this technique. The efficiency currently obtainable thereby is about 20 lm/W.

Concerning the technique of suppressing infrared radiation lights with a microstructure such as those described in Patent documents 6 to 9, there have been reported the effects of enhancing and suppressing lights of only an extremely small part of the wavelength region of the infrared radiation spectrum as reported in Non-patent document 1, but it is extremely difficult to suppress infrared radiation lights over the wide total range of the infrared radiation spectrum. This is because the infrared radiation lights have a property that infrared light of a certain wavelength is suppressed, those of the other wavelengths are enhanced. Therefore, it is considered that it is difficult to attain marked improvement in the efficiency with this technique. Furthermore, the production of the microstructure requires use of a highly advanced microprocessing technique such as the electron beam lithography, and therefore light sources produced by utilizing it becomes extremely expensive. In addition, it has also a problem that even though a microstructure is formed on a W substrate, which is a high temperature resistant material, the microstructure on the surface of W is melted and destroyed at a heating temperature of about 1000° C.

An object of the present invention is to provide a light source device comprising a filament showing high electric power-to-visible light conversion efficiency.

### Means for Achieving the Object

In order to achieve the aforementioned object, the light source device provided by the present invention comprises a translucent gastight container, a filament disposed in the translucent gastight container, and a lead wire for supplying an electric current to the filament. The filament comprises a substrate formed with a metal material and a layer formed with a white scatterer covering the substrate. To the white scatterer layer, a visible light-absorbing material that absorbs lights of visible region is added.

### Effect of the Invention

According to the present invention, infrared light radiation can be reduced and visible light radiation can be enhanced with a filament showing a high reflectance for the infrared wavelength region and a low reflectance for the visible light wavelength region, and therefore a light source device showing a high visible luminous efficiency can be obtained.

### BRIEF DESCRIPTION OF THE DRAWINGS

FIG. 1 is a graph showing wavelength dependency of radiation energy of a conventional tungsten filament.

FIG. 2 is a scanning electron microphotograph showing particle shape of the white scatterer (lutetia) used in the example.

FIG. 3 is a graph showing wavelength dependencies of reflectance and radiation efficiency of a filament substrate (tungsten).

FIG. 4 is a graph showing wavelength dependencies of reflectance and radiation efficiency of a filament comprising a substrate (tungsten) coated with a white scatterer layer that is not doped with impurities or does not contain metal particles.

FIG. 5 is a graph showing wavelength dependencies of reflectance and radiation efficiency of a filament comprising a substrate (tungsten) coated with a white scatterer layer doped with impurities according to the present invention.

FIG. 6 is a graph showing infrared reflection spectra of a white color scatterer not subjected and subjected to dangling bond removing and surface crystal defect restoring treatments.

FIG. 7 is a graph showing wavelength dependencies of reflectance and radiation efficiency of a filament comprising a substrate (tungsten) coated with impurity-doped white scatterer layer subjected to OH group and surface crystal defect removing treatments.

FIG. 8 is a sectional view of the incandescent lamp of the example.

### MODES FOR CARRYING OUT THE INVENTION

The present invention relates to a light source device comprising a translucent gastight container, a filament disposed in the translucent gastight container, and a lead wire for supplying an electric current to the filament. The filament comprises a substrate formed with a metal material and a white scatterer layer covering the substrate. And to the white scatterer layer, a visible light-absorbing material that absorbs lights of visible region is added. With this configuration, the reflectance of the filament can be increased for a wide wavelength range including the infrared region, the reflectance of the same for visible region can be reduced, and therefore when the filament is heated by supply of an electric current or the like, the filament can highly efficiently emit visible lights according to the principle described later.

In other words, the filament comprises a substrate constituted with a metal material and a light-reflecting layer covering the substrate and showing a higher reflectance for infrared lights compared with the substrate, and the light-reflecting layer comprises a reflectance-reducing material that reduces the reflectance of the light scatterer for lights of visible region. The light-reflecting layer can be formed with a white scatterer to which a visible light-absorbing material that absorbs lights of visible region is added as a reflectance-reducing material.

The substrate of the filament is formed with a material containing a metal showing a high melting point, for example, any of HfC (melting point, 4160K), TaC (melting point, 4150K), ZrC (melting point, 3810K), C (melting point, 3800K), W (melting point, 3680K), Re (melting point, 3453K), Os (melting point, 3327K), Ta (melting point, 3269K), Mo (melting point, 2890K), Nb (melting point, 2741K), Ir (melting point, 2683K), Ru (melting point, 2583K), Rh (melting point, 2239K), V (melting point, 2160K), Cr (melting point, 2130K) and Zr (melting point, 2125K).

As the white scatterer, there is used a material containing, for example, any of yttria (Y₂O₃), hafnia (HfO₂), lutetia (Lu₂O₃), thoria (ThO₂), magnesia (MgO), zirconia (ZrO₂), ytterbia (Yb₂O₃), strontia (SrO), calcium oxide (CaO), beryllium oxide (BeO), holmium oxide (Ho₂O₃), zirconium nitride (ZrN), titanium nitride (TiN) and boron nitride (BN). This is because these white scatterers do not substantially absorb lights of the infrared region to the visible region, and show extremely high reflectance for them, and also because, among many kinds of white scatterers, these white scatterers are resistant to high temperatures and maintain high reflectance even in a temperature range of 2300K or higher, in which temperature range the filament sufficiently emits lights. Particles of the white scatterer desirably have a particle diameter not smaller than 50 nm and not larger than 50 μm. Shape of the particles is desirably a shape that allows a large filling factor from the viewpoint of light scattering efficiency. If the method for coating the substrate with the white scatterer is taken into consideration, the white scatterer is desirably in the shape of a spherical particle of good symmetry. The white scatterer is further preferably subjected to at least one of a surface dangling bond removing treatment and a surface crystal defect restoring treatment.

As the visible light-absorbing material, an impurity element doped in the white scatterer can be used. As the impurity element, for example, Ce, Eu, Mn, Ti, Sn, Tb, Au, Ag, Cu, Al, Ni, W, Pb, As, Tm, Ho, Er, Dy, Pr, and so forth can be used. Doping concentration of the impurity element in the white scatterer is set to be, for example, 0.0001 to 10%. As the doping method, there can be used a method of mixing the white scatterer and any of these impurity elements, and allowing a solid phase reaction in the mixture (by sintering the mixture) to attain the doping, or a method of dissolving oxide of the white scatterer and the impurity in concentrated nitric acid, coprecipitating them with an oxalate, and sintering the precipitates.

As the visible light-absorbing material, it is also possible to use metal particles. As the metal particles, there can be used, for example, particles of W, Ta, Mo, Au, Ag, Cu, Al, Ti, Ni, Co, Cr, Si, V, Mn, Fe, Nb, Ru, Pt, Pd, Hf, Y, Zr, Re, Os, Ir, and so forth. These metal particles preferably have a particle diameter not smaller than 2 nm and not larger than 5 μm. Addition concentration of the metal particles in the white scatterer is set to be, for example, 0.0001% to 10%. As the addition method, there is used a method of mixing the white scatterer and any of these impurity elements, electrodepositing them, and then sintering them to allow growth of crystals of metal microparticles in the white scatterer, or a method of injecting ions of any of the aforementioned metals into the white scatterer by using an ion implantation apparatus, and then sintering them to allow growth of crystals of metal microparticles in the white scatterer. The metal particles added to the white scatterer can control absorption wavelength and absorption amount of lights of visible region to be absorbed according to type of the metal and particle diameter, like stained glass seen in churches, and therefore various kinds of absorption bands can be formed. For example, color of stained glass can be changed from pink to dark green by using microparticles of Au and changing the particle diameter thereof from 2 to 5 nm, and in the physical sense, this phenomenon is caused by change of color of transmitting lights induced by the localized resonance absorption effect for lights (complementary color) exerted at the surfaces of the metal microparticles. That is, the microparticles having a small particle size absorb lights of short wavelengths, and those having a larger particle size absorb lights of longer wavelengths. The white scatterer to which the metal microparticles are added absorbs lights according to the same principle.

The surface of the substrate of the filament is preferably polished into a mirror surface. For example, it preferably shows a reflectance of 90% or higher for infrared lights of a wavelength of 4000 nm or longer. If the reflectance is 90% or higher for infrared lights including those of further shorter wavelengths, for example, wavelengths of 1000 nm or longer, further improvement of the luminous efficiency can be expected, and therefore such a characteristic is more preferred. As for surface roughness, the surface of the substrate preferably satisfies at least one of the following conditions: center line average height (Ra) of 1 μm or smaller, maximum height (Rmax) of 10 μm or smaller, and ten-point average roughness (Rz) of 10 μm or smaller.

The filament for light sources of the present invention efficiently emits visible lights when it is heated by supply of an electric current, or the like. The working principle thereof will be explained below on the basis of the Kirchhoff's law for black body radiation.

Loss of energy from the input energy induced by a material (filament in this case) in an equilibrium state under conditions of no natural convection heat transfer (for example, in vacuum) is calculated in accordance with the following equation (1).

[Equation 1]

P(total)=P(conduction)+P(radiation) (1)

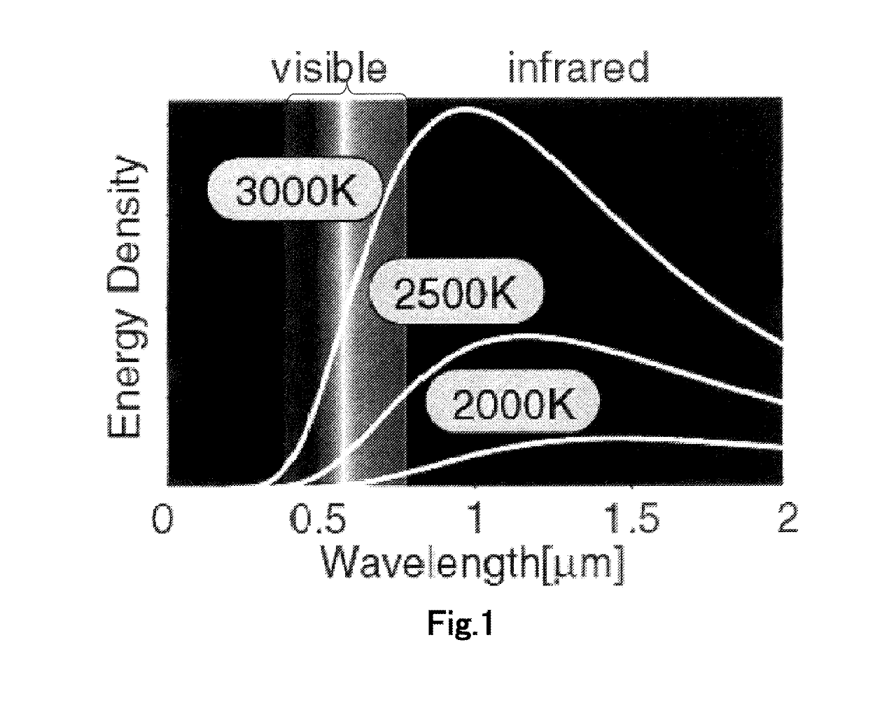

In the above equation, P(total) represents total input energy, P(conduction) represents energy lost through the lead wires for supplying electric current to the filament, and P(radiation) represents energy lost from the filament due to radiation of light to the outside at the heated temperature. At a high temperature of the filament of 2500K or higher, the energy lost from the lead wires becomes as low as only about 5%, and the remaining energy corresponding to 95% or more of the input energy is lost due to the light radiation to the outside. And therefore almost all the input electric energy can be converted into light. However, visible light components of radiation lights radiated from a conventional general filament consist of only about 10% as shown in FIG. 1, and most of them consist of infrared radiation components. Therefore, such a filament as it is cannot serve as an efficient visible light source.

The term of P(radiation) in the aforementioned equation (1) can generally be described as the following equation (2).

$$\begin{matrix}[ Equation 2 ] & \\ P ( Radiation ) = {\int }_{0}^{∞} ɛ ( λ ) \frac{α {λ}^{- 5}}{exp ( β / λ T ) - 1} d λ & ( 2 )\end{matrix}$$

In the equation (2), ε(λ) is emissivity for each wavelength, the term of αλ⁻⁵/(exp(β/λT)−1) represents the Planck's law of radiation, α=3.747×10⁸ Wμm⁴/m², and β=1.4387×10⁴ μmK. The relation of ε(λ) and the reflectance R(λ) is described as the equation (3) according to the Kirchhoff's law.

[Equation 3]

ε(λ)=1−R(λ) (3)

According to both the relations represented by the equations (2) and (3), ε(λ) of a material showing the reflectance of 1 for all the wavelengths is 0 in accordance with the equation (3), thus the integral value in the equation (2) becomes 0, and therefore the material does not cause loss of energy due to radiation. The physical meaning of such a case as mentioned above is that P(total)=P(conduction) in such a case, extremely high temperature of the filament is attained even for a small amount of input energy. That is, when such a material is seen just from the outside, it is impossible to know whether it is at a high temperature or low temperature, even when it is heated, since it shows no radiation, and it can be seen only by touching it.

According to this principle, if the substrate of the filament is covered with the white scatterer layer having the characteristics that it shows no absorption and extremely high reflectance for a wide wavelength range from the infrared region to the visible region (that is, a characteristic of showing extremely low emissivity for a wide wavelength range from the infrared region to the visible region), the radiation thereof can be suppressed for the infrared region to the visible region, even when the filament is heated. However, the white scatterer as it is also suppresses radiation for the visible region, and thus cannot provide a filament showing favorable visible luminous efficiency. Therefore, in order to improve the radiation efficiency of the filament for the visible region with suppressing the radiation for the infrared region in order to obtain favorable visible luminous efficiency, it is necessary to decrease the reflectance (increase the emissivity) for the visible region (refer to the equation (3)). According to the present invention, in order to decrease the reflectance for the visible region, impurity doping methods used in the fluorescent substance techniques and so forth are applied to the white scatterer. Alternatively, a technique of adding metal microparticles is used. An absorption band of the white scatterer is thereby generated for the visible region, and a filament showing high visible luminous efficiency can be realized.

As the method for coating the substrate of the filament with the white scatterer layer to which impurities are added, the following method can be used.

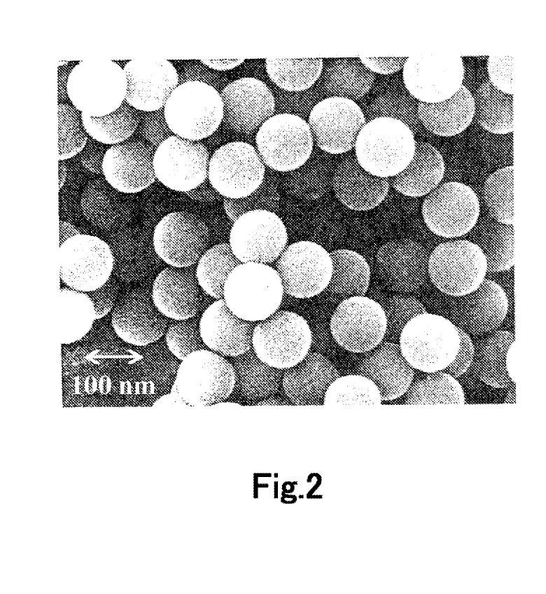

First, particles of a white scatterer (for example, lutetia (Lu₂O₃)) are prepared. In this example, as shown in the scanning electron microphotograph of FIG. 2, spherical lutetia (Lu₂O₃) particles having a particle diameter of 50 nm to 50 μm are prepared as an example. This white scatterer is doped with Ce at a concentration of 1% by the solid phase reaction method. Further, cellulose nitrate is mixed with the white scatterer as a binder, and the mixture is dispersed in a mixed solution of water and polyvinyl alcohol to obtain slurry. This white scatterer in the form of slurry is applied to surface of a filament substrate (for example, W (tungsten)) of a desired shape (for example, wire) separately prepared, and then they are sintered at a predetermined temperature, for example, 400° C. or higher, in an oxidizing atmosphere. The binder is thereby burned, and the filament can be coated with the white scatterer layer doped with the impurities. Besides the aforementioned method, the filament can also be coated with the white scatterer layer doped with impurities by the impact-sintering coating method, in which the white scatterer particles are accelerated and collided to the filament, and instant sintering coating is realized by the impact of the collision.

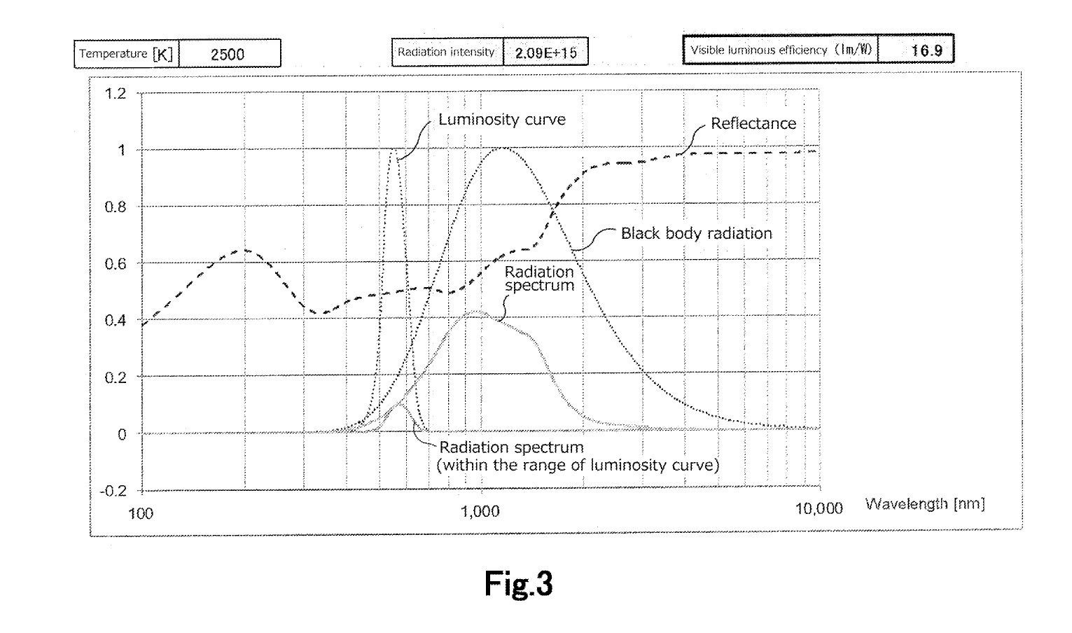

By subjecting surface of a W filament to mechanical polishing, there was prepared a W filament (wire of φ2 mm) mirror-polished so that the surface thereof satisfied at least one of the following requirements concerning surface roughness: center line average height (Ra) of 1 μm or smaller, maximum height (Rmax) of 10 μm or smaller, and ten-point average roughness (Rz) of 10 μm or smaller. Wavelength dependencies of reflectance of this mirror-polished W filament and radiation efficiency (radiation spectrum) of this W filament observed when it is heated to 2500K were obtained by simulation and experiment. The results are shown in FIG. 3. The visible luminous efficiency of this W filament is 16.9 lm/W.

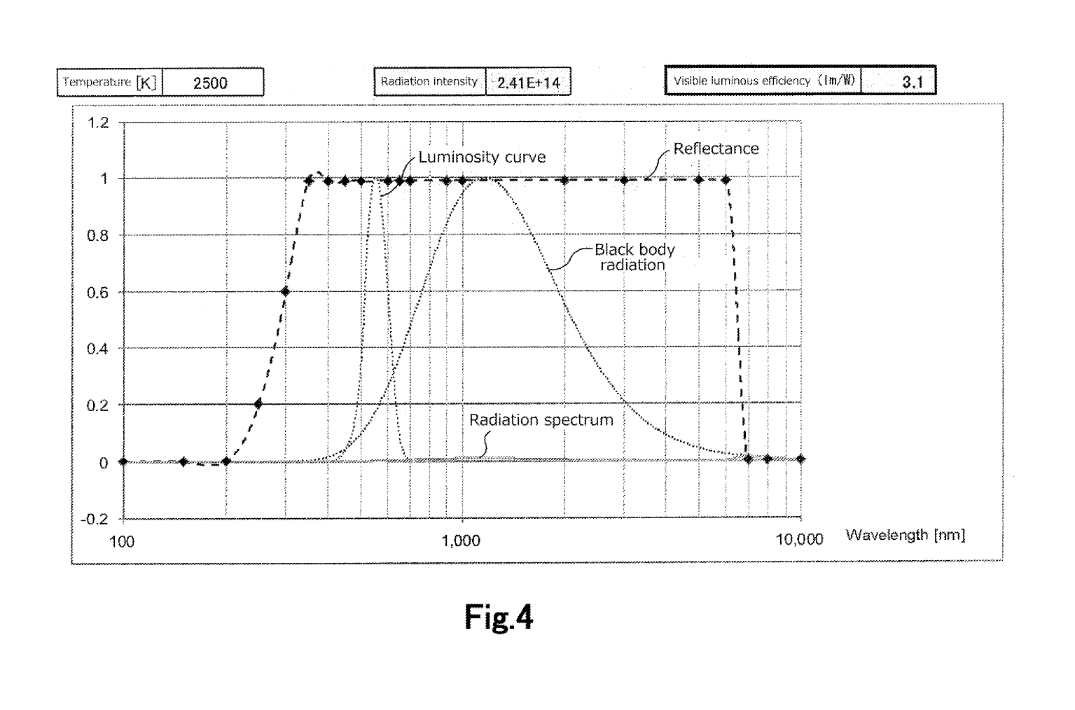

Wavelength dependencies of reflectance and emmisivity (2500K) of a filament obtained by covering the mirror-polished W filament shown in FIG. 3 (substrate) with a white scatterer (Lu₂O₃) layer not doped with impurities and not added with metal particles were obtained by simulation and experiment, and the results are shown in FIG. 4. As shown in FIG. 4, this filament shows extremely high reflectance as high as continuously about 1, and emmissivity of substantially 0 for the ultraviolet region, visible region, and infrared region, because of the action of the white scatterer layer. Therefore, the filament of which characteristics are shown in FIG. 4 shows a low visible luminous efficiency as low as 3.1 lm/W. The low reflectance regions seen in FIG. 4 for the ultraviolet region and the infrared region of wavelength of 7 μm or longer are generated by the conduction band energy absorption by Lu₂O₃ white scatterer (ultraviolet region), and optical phonon absorption by Lu₂O₃ (infrared region; 1 TO phonon, 1 LO phonon, 2 TO phonon, 2 LO phonon, etc.), respectively.

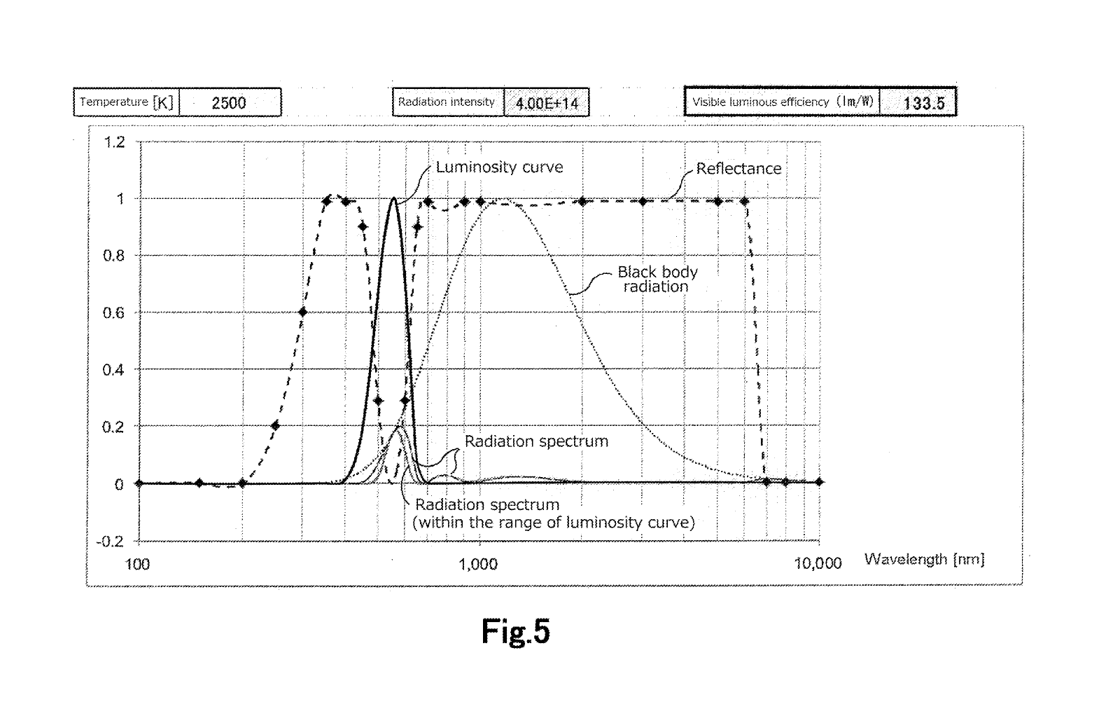

In contrast, wavelength dependency of reflectance and wavelength dependency of radiation efficiency (radiation spectrum, 2500K) of a filament obtained by covering the mirror-polished W filament shown in FIG. 3 (substrate) with a white scatterer (Lu₂O₃) layer doped with about 1% of Ce impurities in a thickness of 100 μm were obtained by simulation and experiment, and the results are shown in FIG. 5. As shown in FIG. 5, there was generated a band where the reflectance is close to 0 for the visible region around 550 nm, which corresponds to the peak of the luminosity curve, due to the doping with the Ce impurities. The radiation efficiency is thereby increased for the visible region. Moreover, it showed an extremely high reflectance value as high as about 1 for the ultraviolet region and the infrared region other than the visible region, due to the action of the white scatterer. The radiation efficiency for the infrared region can be thereby suppressed to be 0.1 or lower. As described above, the filament of the present invention can provide an extremely high visible luminous efficiency of 133.5 lm/W, because it is coated with the white scatterer of which reflectance for the visible region is reduced. This visible luminous efficiency corresponds to approximately 10 times of the efficiency of the conventional incandescent light bulbs.

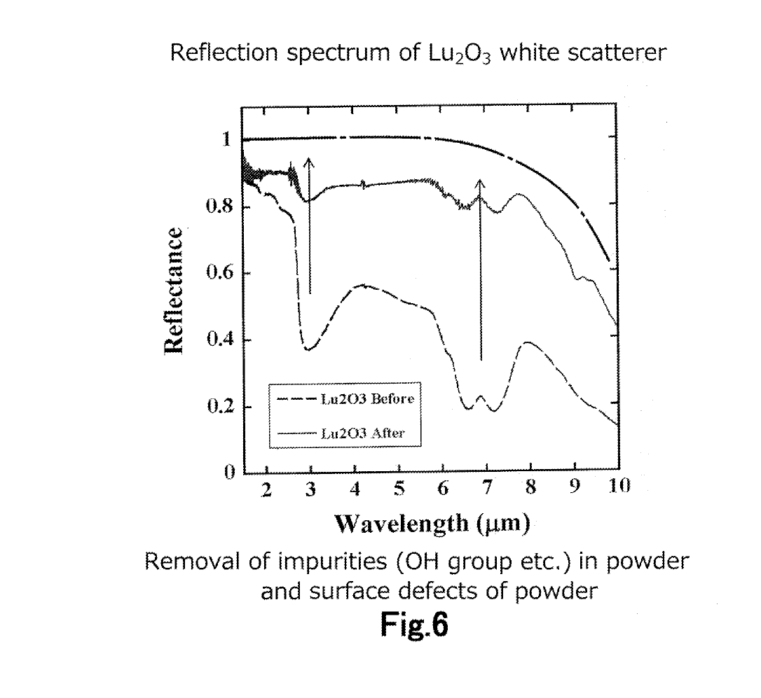

In the white scatterer, OH groups (water) adsorbed on the surface and surface crystal defects (dangling bonds) cause significant absorption for the infrared region as shown in FIG. 6 to cause reduction of reflectance, which leads to reduction of the visible luminous efficiency. Therefore, the white scatterer is desirably subjected to treatments for removing OH groups and crystal defects from the surface of the white scatterer. As the method for the treatments for removing OH groups and crystal defects, widely known methods can be used (refer to M. Hudicky et al., Chemistry of Organic Fluorine Compounds, 2^{nd} ed., Ellis Horwood Ltd., 1976, as reference). Specifically, for example, a method of washing white scatterer particles with NH₄F (buffered hydrofluoric acid) or the like to replace H of the OH group with F can be used. Then, if they are sintered at a high temperature of 1000° C. or higher in vacuum or an oxidizing atmosphere, OF groups are removed, and the crystal defects are restored. By performing a series of these operations, the reflectance can be gradually improved as shown in FIG. 6. The alternate long and short dash line mentioned in FIG. 6 represents the infrared reflection spectrum of the white scatterer particles obtained by repeatedly performing the aforementioned operations.

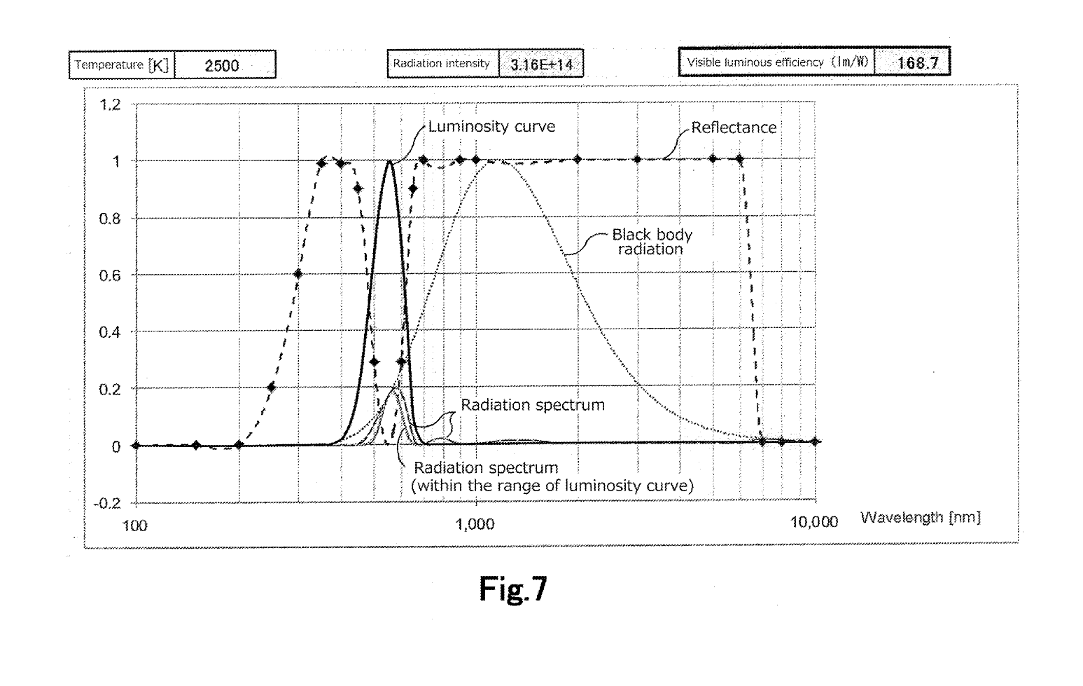

By subjecting the white scatterer to the aforementioned treatments for removing OH groups and crystal defects, the reflectance for the infrared region of 99% of the filament of which characteristics are shown in FIG. 5 not subjected to the treatments can be increased to 99.9%. Wavelength dependency of reflectance and wavelength dependency of radiation efficiency (radiation spectrum) of a filament prepared in the same manner as that for the filament of which characteristics are shown in FIG. 5. A white scatterer subjected to the treatments are also shown in FIG. 7. The visible luminous efficiency at 2500K of the filament of which characteristics are shown in FIG. 7 is 168.7 lm/W, and it can be seen that the visible luminous efficiency can be significantly increased from the visible light luminous efficiency of 133.5 lm/W of the filament of which characteristics are shown in FIG. 5.

Further, it is desirable to optimize thickness of the white scatterer layer to which impurities are doped or metal particles are added in consideration of the following points. That is, if the substrate is coated with the white scatterer layer, the surface area S of the filament increases from the surface area of the substrate in a white scatterer layer thickness-dependent manner. The product of the emissivity ε for the infrared region and the surface area S corresponds to the energy loss (energy leakage in the infrared region). The emissivity for the infrared region of the white scatterer layer is close to 0, but is not completely 0. Therefore, the emissivity and the surface area S are in a trade-off relation, i.e., the emissivity can be made smaller with a larger thickness L of the white scatterer layer by the effect of thickness, but the surface area S also correspondingly becomes larger. Therefore, the thickness of the white scatterer layer is desirably designed to be a thickness providing the minimum product of the emissivity c and the surface area S (=loss of energy), that is, the thinnest thickness required for attaining the desired reflectance.

The particle diameter and the thickness of the white scatterer are optimized by using the light scattering theory, i.e., light diffusion equation.

$$\begin{matrix}[ Equation 4 ] & \\ D {∇}^{2} n ( r , t ) - \frac{1}{{τ}_{a}} n ( r , t ) = \frac{\partial n ( r , t )}{\partial t} & ( 4 ) \\ [ Equation 5 ] & \\ D = \frac{{l}^{*} c}{3} & ( 5 )\end{matrix}$$

In the aforementioned equations (4) and (5), n(r, t) represents light intensity in the white scatterer at an arbitrary time, D represents diffusion coefficient, τₐ represents time of decay due to absorption in a sample, l* represents mean free path, and c represents the speed of light. By solving the aforementioned equations (4) and (5), the light transmissivity T(L) in the case where there is no absorption (τₐ is infinite time) can be simply described as follows.

[Equation 6]

T(L)=(l*/L) (6)

In the equation, L is the thickness of the white scatterer. If there is no absorption, T(L)+R(L) is equal to 1. Therefore, when it is desired to make the reflectance R to be about 99.9%, it is necessary to make the transmissivity T to be about 0.1%. Further, from the calculation of scattering cross section, it is estimated that the mean free path l* and the particle radius of the white scatterer are substantially the same within the particle radius range of 50 nm to 1 μm, and therefore by choosing the minimum radius R=50 nm within the aforementioned range, the minimum mean free path l*, 50 nm, can be chosen. Since the transmissivity T is 0.1%, it can be eventually determined that the thickness of the white scatterer L should be 50 μm or larger from the aforementioned equation (6). In this case, it is determined by theoretical calculation that it is more advantageous to choose a smaller particle radius of the white scatterer in the particle radius range of from 50 nm to 1 μm. However, in actual cases, a smaller particle diameter of the white scatterer makes it more difficult to remove the OH groups (water) adsorbed on the surface of the white scatterer and the crystal defects (dangling bonds) on the surface. Therefore, in order to obtain a white scatterer showing high reflectance and having a sufficient purity and a small particle diameter, many times of washing, sintering, and defect restoration operation are required.

The points to be paid attention at the time of coating the white scatterer over the filament will be described below. Since the white scatterer having a certain thickness is coated on the filament, the surface area of the whole filament increases, and the emissivity suppressing effect of the white scatterer is reduced in a degree corresponding to the increase of the surface area. For example, if a filament of 0.1φ is coated with a white scatterer having a thickness L of 50 μm, it becomes a filament of 0.2φ, and therefore the surface area becomes 4 times larger. Thus, the effective reflectance R in consideration of the surface area becomes 99.6%, and the emissivity ε=1−R becomes 0.4%.

An example of the light source device (incandescent light bulb) using such a filament as described above will be explained.

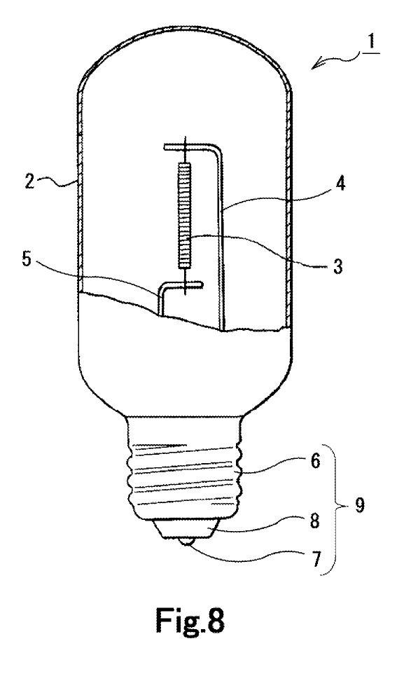

FIG. 8 shows a broken sectional view of the incandescent light bulb using such a filament as described in the aforementioned example. The incandescent light bulb 1 is constituted with a translucent gastight container 2, a filament 3 disposed in the inside of the translucent gastight container 2, and a pair of lead wires 4 and 5 electrically connected to the both ends of the filament 3 and supporting the filament 3. The translucent gastight container 2 is constituted with, for example, a glass bulb. The inside of the translucent gastight container 2 is maintained to be a high vacuum state of 10⁻¹ to 10⁻⁶ Pa. If O₂, H₂, a halogen gas, an inert gas, or a mixed gas of these is introduced into the inside of the translucent gastight container 2 at a pressure of 10⁶ to 10⁻¹ Pa, sublimation and degradation of the visible light reflectance-reducing film formed on the filament are suppressed, and therefore the lifetime-prolonging effect can be expected, as in the conventional halogen lamps.

A base 9 is adhered to a sealing part of the translucent gastight container 2. The base 9 comprises a side electrode 6, a center electrode 7, and an insulating part 8, which insulates the side electrode 6 and the center electrode 7. One end of the lead wire 4 is electrically connected to the side electrode 6, and one end of the lead wire 5 is electrically connected to the center electrode 7.

The filament 3 is the filament of the aforementioned example, and has a structure that the substrate in the form of wire is wound in a spiral shape, and coated with the white scatterer layer doped with impurities or added with metal particles.

As described in the example, the filament 3 shows extremely high reflectance from the ultraviolet region to the infrared region, and low reflectance for the visible region. With this configuration, high visible luminous efficiency (luminous efficiency) can be realized. Therefore, according to the present invention, radiation for the infrared region can be suppressed, and as a result, input electric power-to-visible light conversion efficiency can be increased. Therefore, an inexpensive and efficient energy-saving electric bulb for illumination can be provided.

In the example mentioned above, there is explained an example in which a substrate of which surface is processed into a mirror surface by mechanical polishing is used. However, it is also possible to use a substrate not mirror-polished. Further, the means for the mirror surface processing is not limited to mechanical polishing, and the mirror surface processing can also be performed by any other method. For example, there can be employed wet or dry etching, a method of contacting the filament with a smooth surface at the time of drawing, forging, or rolling, and so forth.

In the aforementioned example, use of the filament of the present invention as a filament of an incandescent light bulb is explained. However, the filament of the present invention can also be used for purposes other than incandescent light bulbs. For example, by doping the white scatterer with impurities so that the reflectance is reduced for the near infrared region (0.8 to 2 μm) (for example, doping with Er), it can be used as an electric wire for heaters, electric wire for welding processing, electron source of thermoelectronic emission (X-ray tube, electron microscope, etc.), and so forth. Also in these cases, the filament can be efficiently heated to high temperature with a little input power because of the infrared light radiation suppressing action (in particular, suppression of the infrared light radiation at longer wavelength), and therefore the energy efficiency can be improved.

### DESCRIPTION OF NUMERICAL NOTATIONS

1 . . . Incandescent light bulb, 2 . . . translucent gastight container, 3 . . . filament, 4 . . . lead wire, 5 . . . lead wire, 6 . . . side electrode, 7 . . . center electrode, 8 . . . insulating part, 9 . . . base

1-13. (canceled)

14. A light source device comprising a translucent gastight container, a filament disposed in the translucent gastight container, and a lead wire for supplying an electric current to the filament, wherein:
the filament comprises a substrate formed with a metal material and a layer formed with a white scatterer covering the substrate, and
a visible light-absorbing material that absorbs lights of visible region is added to the white scatterer layer.

15. A light source device comprising a translucent gastight container, a filament disposed in the translucent gastight container, and a lead wire for supplying an electric current to the filament, wherein:
the filament comprises a substrate formed with a metal material and a light-reflecting layer covering the substrate and showing a higher reflectance for infrared lights compared with the substrate, and the light-reflecting layer comprises a reflectance-reducing material that reduces reflectance of the light-reflecting layer for lights of visible region.

16. The light source device according to claim 15, wherein the light-reflecting layer is formed with a white scatterer to which a visible light-absorbing material that absorbs lights of visible region is added as the reflectance-reducing material.

17. The light source device according to claim 14, wherein the white scatterer contains any of yttria, hafnia, lutetia, thoria, magnesia, zirconia, ytterbia, strontia, calcium oxide, beryllium oxide, holmium oxide, zirconia nitride, titanium nitride, and boron nitride.

18. The light source device according to claim 14, wherein the visible light-absorbing material is an impurity element doped in the white scatterer.

19. The light source device according to claim 18, wherein the impurity element is any of Ce, Eu, Mn, Ti, Sn, Tb, Au, Ag, Cu, Al, Ni, W, Pb, As, Tm, Ho, Er, Dy, and Pr.

20. The light source device according to claim 14, wherein the visible light-absorbing material consists of metal particles.

21. The light source device according to claim 20, wherein the metal particles are particles containing any of W, Ta, Mo, Au, Ag, Cu, Al, Ti, Ni, Co, Cr, Si, V, Mn, Fe, Nb, Ru, Pt, Pd, Hf, Y, Zr, Re, Os, and Ir.

22. The light source device according to claim 21, wherein the metal particles have a particle diameter not smaller than 2 nm and not larger than 5 μm.

23. The light source device according to claim 14, wherein particles of the white scatterer constituting the white scatterer layer have a particle diameter not smaller than 50 nm and not larger than 50 μm.

24. The light source device according to claim 14, wherein the white scatterer is subjected to at least one of a surface-adsorbed molecule removing treatment and a surface crystal defect restoring treatment.

25. The light source device according to claim 16, wherein the white scatterer contains any of yttria, hafnia, lutetia, thoria, magnesia, zirconia, ytterbia, strontia, calcium oxide, beryllium oxide, holmium oxide, zirconia nitride, titanium nitride, and boron nitride.

26. The light source device according to claim 16, wherein the visible light-absorbing material is an impurity element doped in the white scatterer.

27. The light source device according to claim 26, wherein the impurity element is any of Ce, Eu, Mn, Ti, Sn, Tb, Au, Ag, Cu, Al, Ni, W, Pb, As, Tm, Ho, Er, Dy, and Pr.

28. The light source device according to claim 16, wherein the visible light-absorbing material consists of metal particles.

29. The light source device according to claim 28, wherein the metal particles are particles containing any of W, Ta, Mo, Au, Ag, Cu, Al, Ti, Ni, Co, Cr, Si, V, Mn, Fe, Nb, Ru, Pt, Pd, Hf, Y, Zr, Re, Os, and Ir.

30. The light source device according to claim 29, wherein the metal particles have a particle diameter not smaller than 2 nm and not larger than 5 μm.

31. The light source device according to claim 16, wherein particles of the white scatterer constituting the white scatterer layer have a particle diameter not smaller than 50 nm and not larger than 50 μm.

32. The light source device according to claim 16, wherein the white scatterer is subjected to at least one of a surface-adsorbed molecule removing treatment and a surface crystal defect restoring treatment.
